(19) United States
(12) Patent Application Publication
(10) Pub. No.: US 2020/0236539 A1
(43) Pub. Date: Jul. 23, 2020

(54) METHOD FOR PROTECTING PRIVACY ON MOBILE COMMUNICATION DEVICE

(71) Applicant: JPMorgan Chase Bank, N.A., New York, NY (US)

(72) Inventors: Fernando SANTOS, Glasgow (GB); Jarryd Gregory Felix AUBERT, Troon (GB); Scott ANDREW RUNCIMAN, Glasgow (GB); Sheryl GALLACHER, Croslee (GB)

(73) Assignee: JPMorgan Chase Bank, N.A., New York, NY (US)

(21) Appl. No.: 16/745,969

(22) Filed: Jan. 17, 2020

Related U.S. Application Data
(60) Provisional application No. 62/795,192, filed on Jan. 22, 2019.

(51) Int. Cl. H04W 12/02; G06F 21/32; G06F 21/84; G06K 9/00; H04W 12/00

(52) U.S. Cl. CPC H04W 12/02; G06F 21/32; G06F 21/84; H04W 12/0051; G06K 9/00295; G06K 9/00617; G06K 9/00892

(57) ABSTRACT

A method for protecting user privacy on a mobile communication device, such as a smart phone or tablet computing device, is provided. The method includes performing a facial recognition of a user in order to authenticate the user for a normal operation of the device; displaying, on a screen of the device, first content that corresponds to the normal operation of the device by the authenticated user; detecting a presence of a face of a second person that is different from the authenticated user; and displaying, on the screen, second content that corresponds to a predetermined safety screen, such that the first content is hidden from being displayed. The method may be implemented such that the safety screen is displayed in response to detecting an aversion of the eyes of the authenticated user.

### CROSS-REFERENCE TO RELATED APPLICATION

This application claims the benefit of U.S. Provisional Patent Application Ser. No. 62/795,192, filed Jan. 22, 2019, which is hereby incorporated by reference in its entirety.

### BACKGROUND

### 1. Technical Field

The present disclosure relates to the field of mobile communication devices, such as smart phones and tablet computing devices. More particularly, the present disclosure relates to a method for protecting user privacy when using a mobile device.

### 2. Background

Mobile communication devices, such as smart phones and tablet computing devices, have become ubiquitous in recent years, due largely to the multitude of functionalities that are available to users and also due to the portability of the devices. As a result, it has become quite common for users to use such devices in public spaces.

For privacy protection, many mobile communication devices include mechanisms for performing user authentication, in order to ensure that a particular device is usable only by its rightful owner. In some instances, authentication may be performed by providing an input, such as, for example, a security code or a touch sequence with respect to a pattern that is displayed on the display of the device. In other instances, authentication may be performed by biometric input, such as, for example, a fingerprint input or facial recognition. In some instances, a particular device may be configured to perform several or all of these different modes of authentication.

In some situations, a user may desire to use a mobile communication device in a public space, but also to maintain a degree of privacy with respect to the content being displayed on the device. When the user is aware of the presence of another person that may be attempting to view the display of the device, the user may be able to hide the display from that person's view. However, a possibility that a user may be unaware of the presence of another person that is attempting to view the display of the device presents a problem to be resolved.

Accordingly, there is a need for a method and system for protecting user privacy when using a mobile device.

### SUMMARY

The present disclosure, through one or more of its various aspects, embodiments, and/or specific features or sub-components, provides, inter alia, various systems, servers, devices, methods, media, programs, and platforms for protecting user privacy when using a mobile device.

According to an aspect of the present disclosure, a method for protecting user privacy on a mobile communication device is provided. The method is implemented by a processor of the mobile communication device. The method includes performing, by the processor, a facial recognition of a first person in order to authenticate the first person for a normal operation of the mobile communication device; displaying, on a screen of the mobile communication device, first content that corresponds to the normal operation of the mobile communication device by the authenticated first person; detecting, by the processor, a presence of a face of a second person that is different from the authenticated first person; and displaying, on the screen, second content that corresponds to a predetermined safety screen, such that the first content is hidden from being displayed.

The method may further include: detecting, by the processor, that the face of the second person is no longer present; and displaying, on the screen, the first content

The predetermined safety screen may be a blank screen.

The predetermined safety screen may include a textual message that indicates that the screen content is being hidden for a security purpose.

The predetermined safety screen may include a user-selectable pictorial image.

According to another aspect of the present disclosure, a method for protecting user privacy on a mobile communication device is provided. The method is implemented by a processor of the mobile communication device. The method includes: performing, by the processor, a facial recognition of a first person in order to authenticate the first person for normal operation of the mobile communication device; displaying, on a screen of the mobile communication device, first content that corresponds to the normal operation of the mobile communication device by the authenticated first person; detecting, by the processor, an aversion of eyes of the authenticated first person from the screen of the mobile communication device; and displaying, on the screen, second content that corresponds to a predetermined safety screen, such that the first content is hidden from being displayed.

The method may further include: detecting, by the processor, that the eyes of the authenticated first person are no longer averted from the screen of the mobile communication device; and displaying, on the screen, the first content.

The predetermined safety screen may be a blank screen.

Alternatively, the predetermined safety screen may include a textual message that indicates that the screen content is being hidden for a security purpose.

As another alternative, the predetermined safety screen may include a user-selectable pictorial image.

According to yet another exemplary embodiment, a mobile communication device is provided. The mobile communication device includes a processor and a display screen. The processor is configured to: perform a facial recognition of a first person in order to authenticate the first person for a normal operation of the mobile communication device; display, on the display screen, first content that corresponds to the normal operation of the mobile communication device by the authenticated first person; detect a presence of a face of a second person that is different from the authenticated first person; and display, on the display screen, second content that corresponds to a predetermined safety screen, such that the first content is hidden from being displayed.

The processor may be further configured to detect that the face of the second person is no longer present; and display, on the screen, the first content.

The predetermined safety screen may be a blank screen.

Alternatively, the predetermined safety screen may include a textual message that indicates that the screen content is being hidden for a security purpose.

As another alternative, the predetermined safety screen may include a user-selectable pictorial image.

According to still another exemplary embodiment, a mobile communication device is provided. The mobile communication device includes a processor and a display screen. The processor is configured to: perform a facial recognition of a first person in order to authenticate the first person for a normal operation of the mobile communication device; display, on the display screen, first content that corresponds to the normal operation of the mobile communication device by the authenticated first person; detect an aversion of eyes of the authenticated first person from the screen of the mobile communication device; and display, on the display screen, second content that corresponds to a predetermined safety screen, such that the first content is hidden from being displayed.

The processor may be further configured to: detect that the eyes of the authenticated first person are no longer averted from the screen of the mobile communication device; and display, on the screen, the first content.

The predetermined safety screen may be a blank screen.

Alternatively, the predetermined safety screen may include a textual message that indicates that the screen content is being hidden for a security purpose.

As another alternative, the predetermined safety screen may include a user-selectable pictorial image.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a mobile communication device that provides several applications that are available for use by a user.

FIG. 3 is a flowchart of an exemplary first process for protecting privacy of a user of a mobile communication device.

FIG. 4 is a flowchart of an exemplary second process for protecting privacy of a user of a mobile communication device.

FIG. 5 is an exemplary illustration of a mobile communication device that displays a blank screen as a safety screen.

FIG. 6 is an exemplary illustration of a mobile communication device that displays a textual message indicating that the screen content is being hidden for a security purpose as a safety screen.

FIG. 7 is an exemplary illustration of a mobile communication device that displays a user-selectable pictorial image as a safety screen.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

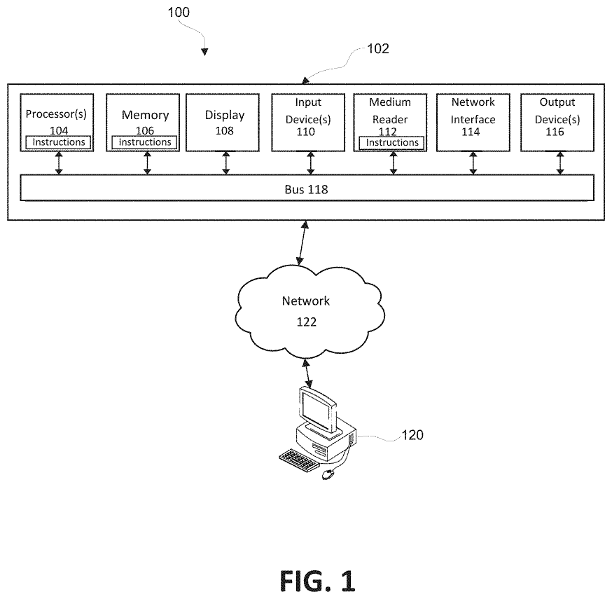

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a video display 108, such as a liquid crystal display (LCD), an organic light emitting diode (OLED), a flat panel display, a solid state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may he, but is not limited to, a speaker, an audio out, a video out, a remote control output, a printer, or any combination thereof.

Each of the components of the computer system 102 may be interconnected and. communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

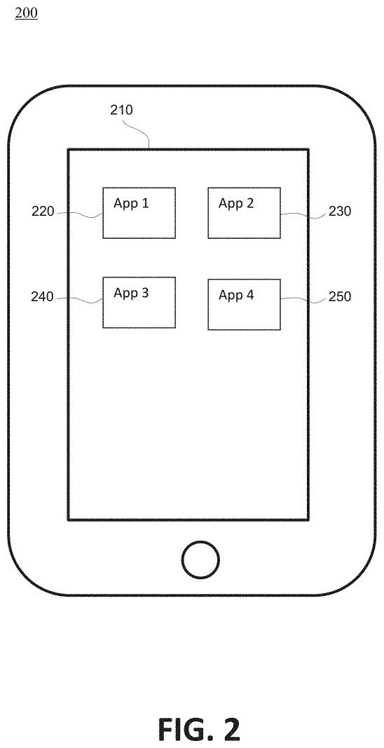

Referring to FIG. 2, a schematic of a mobile communication device 200 is illustrated. The mobile communication device 200 may be, for example, a smart phone or a table computing device. The mobile communication device 200 includes a display screen 210 on which icons 220, 230, 240, 250 correspond to applications that may be executed by the user. In an exemplary embodiment, the display screen 210 is a touch screen, and a user may use a touch of a finger or a stylus to execute an application that corresponds to the touched portion of the screen.

In an exemplary embodiment, the mobile communication device 200 includes a facial recognition capability that may, for example, be used to perform user authentication. In this regard, an owner of the mobile communication device 200 may desire to disable or lock the device 200 so that unauthenticated users cannot access the data stored on the device 200 or otherwise make use of the device 200. The device 200 may include one or more mechanisms for unlocking the device by authenticating the user, such as, for example, providing a security code or a touch sequence with respect to a pattern; or providing a biometric input, such as, for example, a fingerprint input or facial recognition. In some instances, a device 200 may facilitate several or all of these different modes of authentication.

When the device 200 has a facial recognition capability, the owner or other authenticated user may implement this capability by using the device 200 to capture an image of the face of the owner or authenticated user. This image is then stored in the device 200 and used for subsequent authentications by comparing the stored image with that of a person that is attempting to unlock the device. In this manner, the device 200 effectively has an ability to determine whether or not the screen of the device 200 is being viewed by an authenticated user, i.e., a person whose facial image has previously been captured and stored in the device, or by another, unauthenticated user, i.e., any other person.

Accordingly, when the mobile communication device 200 has been unlocked by an authenticated user and is being used to perform a function, such as, for example, a function that entails displaying content on the display screen 210 for viewing by the authenticated user, there may be a circumstance in which a second person attempts to view the content that is displayed on the screen 210. This situation may be referred to as “shoulder surfing”, i.e., a second person that is looking at the screen 210 over the shoulder of the authorized user. In this regard, the second person may be referred to as a “snooper”, i.e., a person that is attempting to view the information in a manner that invades the privacy of the authenticated user. In some instances, especially when the device 200 is being used in a relatively crowded environment, the authenticated user may not be aware of the intrusion by the snooper.

In an exemplary embodiment, the mobile communication device 200 may implement a capability to detect the presence of the second person. In particular, the mobile communication device 200 may use the facial recognition capability to detect a face of a second person. In this regard, the facial recognition capability may be utilized to detect either or both of a number of faces and whether a particular face matches with the facial images stored in the device 200.

In an exemplary embodiment, when the mobile communication device 200 uses the facial recognition capability to detect a presence of a second person, the device 200 may be configured to display a predetermined safety screen on the display screen 210. By displaying the safety screen, the content that was previously being displayed is effectively hidden from view, thereby protecting the privacy of the authenticated user. The safety screen may be, for example, any of a blank screen, a screen that shows a textual or pictorial message indicating that the screen is privacy protected, a photographic image, or any other type of image or display screen. The safety screen also effectively alerts the authenticated user of the presence of the snooper. The device 200 may be further configured to use the facial recognition capability to continuously monitor whether the snooper remains present, and when a determination is made that the snooper is no longer present, to restore the display of previous content to the display screen 210. In an exemplary embodiment, the device 200 may utilize a face tracking functionality in order to effectuate a continuous monitoring of whether or not the snooper remains present.

In an exemplary embodiment, when the mobile communication device 200 uses the facial recognition capability to detect that the eyes of the authenticated user are averted from the display screen 210, the device 200 may be configured to display the predetermined safety screen on the display screen 210. The device 200 may be further configured to use the facial recognition capability to continuously monitor whether the eyes of the authenticated user have reappeared within the field of view of the display screen 210, and when a determination is made that the eyes of the authenticated user are present, to restore the display of previous content to the display screen 210. In an exemplary embodiment, the device 200 may utilize a face tracking functionality in order to effectuate a continuous monitoring of whether or not the eyes of the authenticated user are averted from the display screen 210.

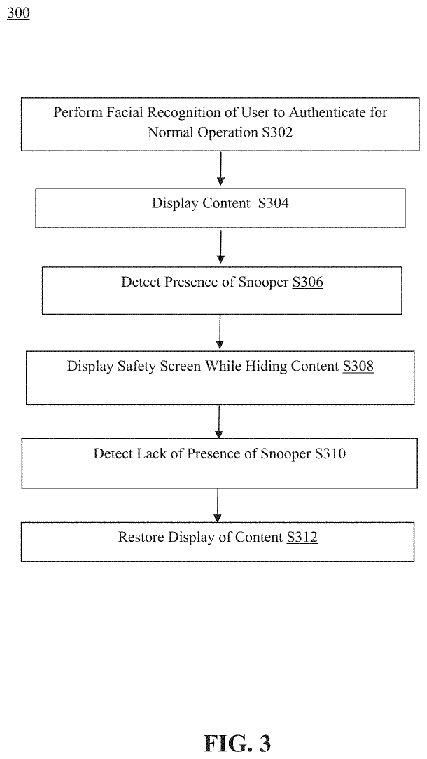

An exemplary first process for protecting privacy of a user of a mobile communication device is generally indicated at flowchart 300 in FIG. 3.

In the process 300 of FIG. 3, at step S302, a processor of a mobile communication device 200 performs a facial recognition of a user in order to authenticate the user for normal operation of the mobile communication device 200. In this regard, an owner or other legitimate user of the mobile communication device 200 will have previously used the device 200 to capture an image of his/her face and to store the captured image in its memory, and thus, the device 200 is capable of performing a facial recognition operation by capturing a facial image of the user and comparing the newly captured image with the previously stored image.

At step S304, a display of content is provided on a display screen 210 of the mobile communication device 200. The content to be displayed may include any type of content that relates to a no al operation of the device 200, such as, for example, an e-mail message, a text message, a photograph, a video, a web page, and/or any other type of content that is suitable for display on the screen 210.

At step S306, the presence of a snooper is detected. In particular, the mobile communication device 200 uses its facial recognition function to detect a presence of a second person that is unauthenticated. Then, at step S308, a safety screen is displayed on the display screen 210 while hiding the content that was previously being displayed. In this manner, the privacy of the authenticated user is protected by hiding the display of the content and thereby preventing the ability of the snooper to view the content.

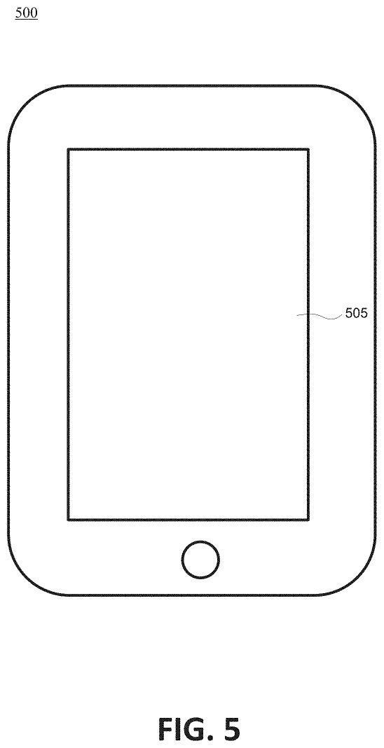

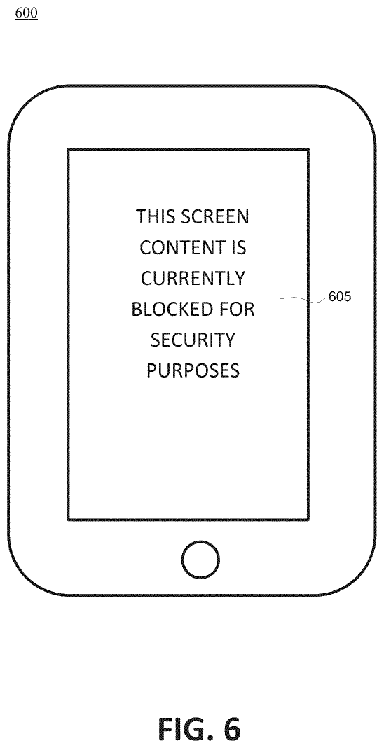

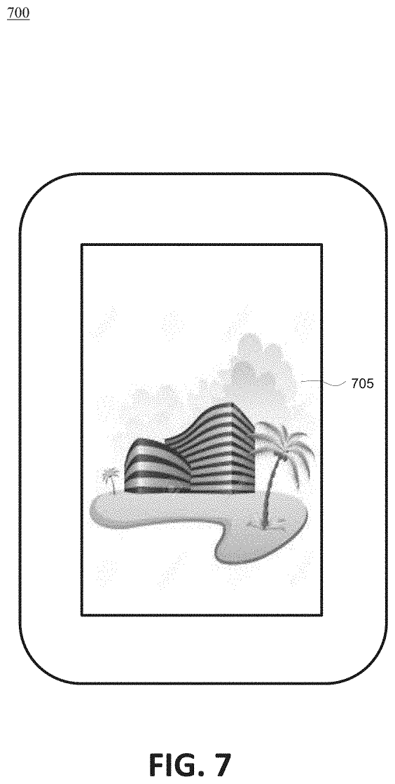

The safety screen may include, for example, any of a blank screen, a screen that shows a textual or pictorial message indicating that the screen is privacy protected, a photographic image, or any other type of image or display screen. For example, referring to FIG. 5, a safety screen 500 may include a display of a blank screen 505. As another example, referring to FIG. 6, a safety screen 600 may include a textual message 605 indicating that the screen content is being hidden for a security purpose. As yet another example, referring to FIG. 7, a safety screen 700 may include a user-selectable pictorial image 705.

At step S310, the lack of presence of the snooper is detected. In particular, the mobile communication device 200 uses its facial recognition function to continuously monitor which faces are within its field of view, and continues to display the safety screen as long as a face of at least one unauthenticated user is detected. Then, when it is determined that there are no faces of unauthenticated users present, the mobile communication device 200 determines that it is safe to return to normal operation. Thus, at step S312, the display of the safety screen is removed, and the display of content that had previously been hidden is restored. In an exemplary embodiment, the device 200 may utilize a face tracking functionality in order to effectuate a continuous monitoring of whether or not any faces of unauthenticated users remain present.

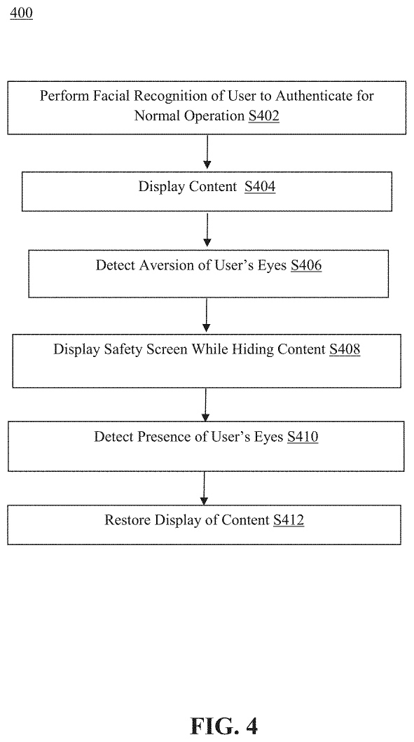

An exemplary second process for protecting privacy of a user of a mobile communication device is generally indicated at flowchart 400 in FIG. 4.

In the process 400 of FIG. 4, at step S402, the processor of the mobile communication device 200 performs a facial recognition of a user in order to authenticate the user for normal operation of the mobile communication device 200. In this regard, similarly as described above with respect to step S302 of FIG. 3, an owner or other legitimate user of the mobile communication device 200 will have previously used the device 200 to capture an image of his/her face and to store the captured image in its memory, and thus, the device 200 is capable of performing a facial recognition operation by capturing a facial image of the user and comparing the newly captured image with the previously stored image.

At step S404, a display of content is provided on a display screen 210 of the mobile communication device 200. Similarly as described above with respect to step S304 of FIG. 3, the content to be displayed may include any type of content that relates to a normal operation of the device 200, such as, for example, an email message, a text message, a photograph, a video, a web page, and/or any other type of content that is suitable for display on the screen 210.

At step S406, an aversion of the eyes of the authenticated user is detected. In particular, the mobile communication device 200 uses its facial recognition function to detect that the authenticated user is not currently viewing the display screen 201. Then, at step S408, a safety screen is displayed on the display screen 210 while hiding the content that was previously being displayed. In this manner, the privacy of the authenticated user is protected by hiding the display of the content and thereby preventing a potential ability of an unauthenticated person to view the content.

Similarly as described above with respect to step S308 of FIG. 3, the safety screen may include, for example, any of a blank screen, a screen that shows a textual or pictorial message indicating that the screen is privacy protected, a photographic image, or any other type of image or display screen. For example, referring to FIG. 5, a safety screen 500 may include a display of a blank screen 505. As another example, referring to FIG. 6, a safety screen 600 may include a textual message 605 indicating that the screen content is being hidden for a security purpose. As yet another example, referring to FIG. 7, a safety screen 700 may include a user-selectable pictorial image 705.

At step S410, the presence of the eyes of the authenticated user is detected. In particular, the mobile communication device 200 uses its facial recognition function to continuously monitor whether any faces are within its field of view, and continues to display the safety screen as long as no faces are detected or a face of at least one unauthenticated user is detected. Then, when it is determined that the only face that is present is that of an authenticated user, the mobile communication device 200 determines that it is safe to return to normal operation. Thus, at step S412, the display of the safety screen is removed, and the display of content that had previously been hidden is restored. In an exemplary embodiment, the device 200 may utilize a face tracking functionality in order to effectuate a continuous monitoring of whether or not the eyes of the authenticated user are averted from the display screen 210.

Accordingly, with this technology, a process for protecting the privacy of a user of a mobile communication device is provided. The process protects user privacy by using facial recognition technology to detect the presence of a snooper and/or to detect an aversion of the eyes of an authenticated user, and when such a detection occurs, to display a safety screen in place of displaying content that is associated with normal operation of the device, thereby preventing a potential for a snooper or unauthenticated user to view content that may be private or sensitive.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, or as applications that are downloadable to mobile communication devices, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for protecting user privacy on a mobile communication device, comprising:
performing, by a processor of the mobile communication device, a facial recognition of a first person in order to authenticate the first person for a normal operation of the mobile communication device;
displaying, on a screen of the mobile communication device, first content that corresponds to the normal operation of the mobile communication device by the authenticated first person;
detecting, by the processor, a presence of a face of a second person that is different from the authenticated first person; and
displaying, on the screen, second content that corresponds to a predetermined safety screen, such that the first content is hidden from being displayed.

2. The method of claim 1, further comprising:
detecting, by the processor, that the face of the second person is no longer present; and
displaying, on the screen, the first content.

3. The method of claim 1, wherein the predetermined safety screen is a blank screen.

4. The method of claim 1, wherein the predetermined safety screen includes a textual message that indicates that the screen content is being hidden for a security purpose.

5. The method of claim 1, wherein the predetermined safety screen includes a user-selectable pictorial image.

6. A method for protecting user privacy on a mobile communication device, comprising:
performing, by a processor of the mobile communication device, a facial recognition of a first person in order to authenticate the first person for normal operation of the mobile communication device;
displaying, on a screen of the mobile communication device, first content that corresponds to the normal operation of the mobile communication device by the authenticated first person;
detecting, by the processor, an aversion of eyes of the authenticated first person from the screen of the mobile communication device; and
displaying, on the screen, second content that corresponds to a predetermined safety screen, such that the first content is hidden from being displayed.

7. The method of claim 6, further comprising:
detecting, by the processor, that the eyes of the authenticated first person are no longer averted from the screen of the mobile communication device; and
displaying, on the screen, the first content.

8. The method of claim 6, wherein the predetermined safety screen is a blank screen.

9. The method of claim 6, wherein the predetermined safety screen includes a textual message that indicates that the screen content is being hidden for a security purpose.

10. The method of claim 6, wherein the predetermined safety screen includes a user-selectable pictorial image.

11. A mobile communication device, comprising:
a processor; and
a display screen,
wherein the processor is configured to:
perform a facial recognition of a first person in order to authenticate the first person for a normal operation of the mobile communication device;
display, on the display screen, first content that corresponds to the normal operation of the mobile communication device by the authenticated first person;
detect a presence of a face of a second person that is different from the authenticated first person; and
display, on the display screen, second content that corresponds to a predetermined safety screen, such that the first content is hidden from being displayed.

12. The mobile communication device of claim 11, wherein the processor is further configured to:
detect that the face of the second person is no longer present; and
display, on the screen, the first content.

13. The mobile communication device of claim 11, wherein the predetermined safety screen is a blank screen.

14. The mobile communication device of claim 11, wherein the predetermined safety screen includes a textual message that indicates that the screen content is being hidden for a security purpose.

15. The mobile communication device of claim 11, wherein the predetermined safety screen includes a user-selectable pictorial image.

16. A mobile communication device, comprising:
a processor; and
a display screen,
wherein the processor is configured to:
perform a facial recognition of a first person in order to authenticate the first person for a normal operation of the mobile communication device;
display, on the display screen, first content that corresponds to the normal operation of the mobile communication device by the authenticated first person;
detect an aversion of eyes of the authenticated first person from the screen of the mobile communication device; and
display, on the display screen, second content that corresponds to a predetermined safety screen, such that the first content is hidden from being displayed.

17. The mobile communication device of claim 16, wherein the processor is further configured to:
detect that the eyes of the authenticated first person are no longer averted from the screen of the mobile communication device; and
display, on the screen, the first content.

18. The mobile communication device of claim 16, wherein the predetermined safety screen is a blank screen.

19. The mobile communication device of claim 16, wherein the predetermined safety screen includes a textual message that indicates that the screen content is being hidden for a security purpose.

20. The mobile communication device of claim 16, wherein the predetermined safety screen includes a user-selectable pictorial image.
